(19) United States
(12) Patent Application Publication
(10) Pub. No.: US 2006/0085391 A1
(43) Pub. Date: Apr. 20, 2006

(54) Automatic query suggestions

(75) Inventors: Andrzej Turski, Redmond, WA (US); Lili Cheng, Bellevue, WA (US); Matthew B. MacLaurin, Woodinville, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/950,084

(22) Filed: Sep. 24, 2004

(51) Int. Cl. G06F 17/30

(52) U.S. Cl. 707/3

(57) ABSTRACT

An improved technique of querying a data store by widening the query using a series of queries that follow relations between items. Initial auxiliary queries are used to find metadata property values (rather than the actual items) that are then used in the subsequent queries. The initial queries employ one or more property values to find a related item. In response thereto, an action menu is presented for the item that facilitates widening the search for all other items with the same selected property value. The user can be presented with several choices depending on which property is used for query widening.

### TECHNICAL FIELD

This invention is related to systems and methods that facilitate data searching via automated query suggestions.

### BACKGROUND OF THE INVENTION

The amount of data stored electronically has grown tremendously due to advances in circuit miniaturization and the availability to provide access to such information via networks such as the Internet. This information includes everything from e-mail messages to patient records to web pages. More specifically, much of the growth in stored data is a direct result of the explosion in the number of web pages. Anyone who has attempted to search the Internet or a large data store knows, however, that web pages and database records are practically useless unless they can be searched rapidly, accurately, and efficiently. Thus, there is a never-ending effort to enhance searching of such large volumes of information by providing search engines that use a variety of techniques.

A conventional technique employed to query a database or data store of items is by “query refinement” which works from a top-down perspective. That is, a first query of the data store returns a result set, and if the result set is too large to be browsed directly, the search can be narrowed by issuing a second query that acts on the result set of the first query. This process can be repeated several times as needed to arrive at a more manageable result set.

Query refinement can be an efficient means to localize a sought-after item if a sufficient number of item properties are well known. However, an item being searched for is often known not for its properties, but rather for associations with other items. In accordance with query refinement, some conventional search engines provide a user with possible or suggested terms to be added to a search. For example, the search engine might suggest that for a query related to “patent” one of the following terms can be added: “invention”, “intellectual”, or “property”. Thus, the new search could be, e.g., “patent invention or “patent property”. The suggested query is not a coherent phrase but rather a jumble of related words, a flaw that suggests terms which do not necessarily focus a user's search. An additional flaw with these current search engines is that the list of suggested terms is not dynamically updated to reflect the most popular or most requested records.

A more effective method of searching encompasses a search process that mimics human thinking where initial auxiliary queries oftentimes are used to find not the actual items, but rather one or more property values of metadata, e.g., a date, to be used in the subsequent queries. For example, a user may be searching for documents authored by a job candidate. In such case, the user may not know the title or content of the documents, or even the name of the author. All the user might remember is that an e-mail was received by the person. Consequently, the user would need to query for related items (e.g., the particular e-mail) that will provide a property value (e.g., the name of the person) before the user queries for the items themselves (e.g., the documents).

In furtherance thereof, what is needed is an improved technique for querying a data store.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, provides for an improved technique of querying a data store by expanding a base query via employment of a series of consecutive queries that follow relations between items. Initial auxiliary queries are used to determine metadata property values (rather than the actual items) that are then utilized in subsequent queries. The initial queries employ one or more property values to locate a related item. In response thereto, an action menu is presented for the item that facilitates broadening the search for other items with a same selected property value. A user can be presented with several choices depending on which property is used for query expansion.

In another aspect of the subject invention, a second approach is provided such that a widened query is an action command on a nested query (or a property value representing a query). One or more initial query refinements are performed to return items that facilitate defining a related query. A scope of the nested query is then expanded by promoting the nested query to a top level, and continuing the search for other related items.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates searching a data store of items in accordance with the subject invention.

FIG. 2 illustrates a flow diagram of one representation of the first implementation of the invention.

FIG. 3 illustrates a flow chart of one methodology of query by association in accordance with the invention.

FIG. 4 illustrates a diagram of a query by association process where the query is widened by promoting a nested query to a top-level search in accordance with the invention.

FIG. 5 illustrates a flow chart of another methodology of query by association that promotes the nested query to the top level in accordance with the invention.

FIG. 6 illustrates a block diagram of a system that employs artificial intelligence to facilitate searching the data store of items in accordance with the subject invention.

FIG. 7 illustrates a screenshot of results of an initial query to find a related item, where the related item is used to widen the search in accordance with the subject invention.

FIG. 8 illustrates a screenshot of search results that are returned from executing a widened query “More items by this author” as selected by the user in accordance with the invention.

FIG. 9 illustrates a screenshot of results returned using a conventional search that sorts e-mail by date.

FIG. 10 illustrates a screenshot of a second-level sub-query that is created by narrowing the initial “JPEG Image” query to a specific day, with an option to widen the sub-query to the top-level query in accordance with the subject invention.

FIG. 11 illustrates a screenshot of a widened query “All items from same day” where a related sub-query is found and then promoted to a top level search in accordance with the subject invention.

FIG. 12 illustrates a block diagram of a computer operable to execute the disclosed architecture.

FIG. 13 illustrates a schematic block diagram of an exemplary computing environment in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Query Widening

The disclosed architecture enables a series of queries on a data store of items, which queries follow relations between items, referred to herein as “query by association” or “query widening.” It draws from an observation of human thinking where initial auxiliary queries oftentimes are used to find not the actual items, but rather one or more property values of metadata, e.g., a date, to be used in the subsequent queries. The disclosed type of searching is a good optimization to traditional query refinement techniques.

The “query by association” architecture can be implemented in at least two ways. In a first implementation, initial queries are used to find a related item. Once the related item is found, an action menu is presented for the item that includes one or more “widened queries”. These widened queries search for all other related items with the same selected property value of the metadata. The system will present several widening choices to a user depending on which property is used for query widening. It is to be appreciated that any item property can be used for query widening, though the practical applications may bring forward only a few of the most useful ones. Typically, widened queries are presented as commands on a right-click menu of a user interface (UI). Other UI representations are also possible.

In a second implementation, “query by association” involves employing the query refinement technique from a top level down to determine a query (a “related query”) that returns related items. Since refinement is used, the related query will have one or more nested queries. The search is then widened by promoting the final nested query to the top level. In effect, the architecture facilitates narrowing the search down until the related query is found, and then widening the search based on the nested query to return all other related items.

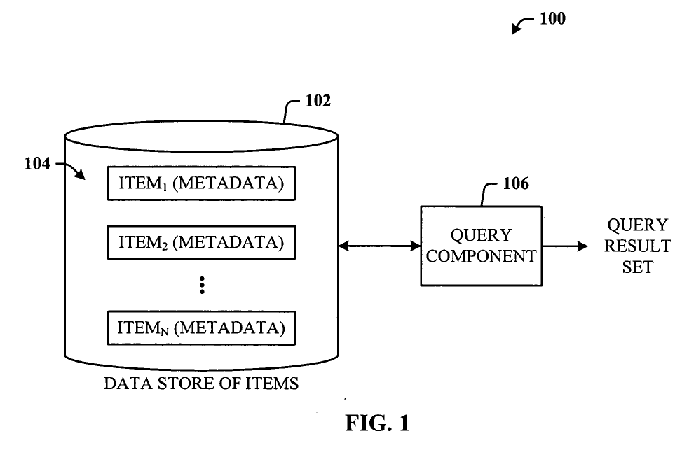

Referring now to FIG. 1, there is illustrated a system 100 that facilitates searching a data store (or database) 102 of items in accordance with the subject invention. The data store 102 includes data items 104 (denoted ITEM₁, ITEM₂, . . . ,ITEM_{N}) any or all of which have associated therewith metadata. A query component 106 interfaces to the data store 102 to facilitate one or more queries on the data store of items 102, which queries can eventually output a query result set.

In accordance with the first implementation, the query component 106 processes one or more initial queries against the data store 102 to find one or more related items (e.g., ITEM₁ and/or ITEM₂). Once the one or more related items are found, the user can choose to widen a according to one of the items (ITEM₁ or ITEM₂) by selecting a property value of the metadata associated with that item. This widened query searches for all other related items having the same metadata property value.

In a further optimization of the first implementation, the query component facilitates complex queries on the data store of items 102, such that once the one or more related items have been found, the user can choose two or more metadata property values to widen the query. Thus, the result set is other related items that include metadata having those two or more property values.

In accordance with the second implementation, the query component 106 employs a query refinement technique that works down from a top level to determine a query (a “related query”) that returns related items. Once the one or more related items (e.g., ITEM₁ and/or ITEM₂) have been found, the related query can be identified. The query component 106 facilitates extracting a nested query from the related query, and promotes the nested query to the top level, which in effect widens the search based on the nested query to return all other related items.

The nested query will have returned a result set of one or more items, each of which has metadata associated therewith. Thus, instead of promoting the nested query to the top level, a portion of the metadata can be promoted to the top level and the search conducted based thereon. As indicated herein, the metadata can include one or more properties that can be extracted from any of the items of the results set. By utilizing one or more of the properties to widen the search, it is possible that the result set returned by the widened search will include other related items that were not included in the initial result set of related items.

Another variation of the second implementation may occur if there is more then one level of nested queries. Instead of promoting the inner-most query, we may promote to the top level one of the queries in the middle of the query chain. In that case, we eliminate the parent queries to the promoted one, but retain all of its nested queries. Yet another option is to drop one of queries in the query chain, but retain both its parents and children. This can be regarded as promoting the nested query one level up instead of to the top level. Any other combination of described implementations is also possible.

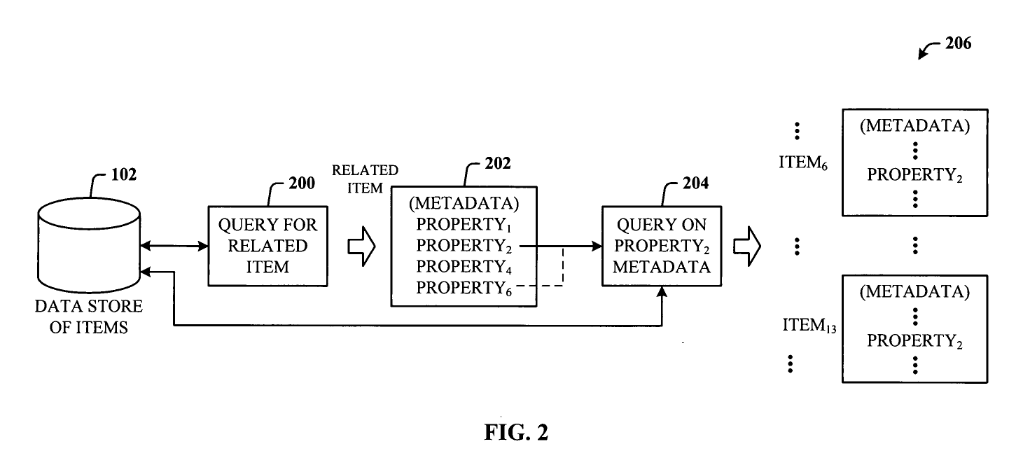

Referring now to FIG. 2, a flow diagram depicts one particular implementation of the invention. A query 200 is performed on the data store 102 for one or more items that relate to the query. Once the one or more related items are found, the user can choose one of the related items 202 to widen the search by selecting a metadata property of that related item 202. For example, given that the related item 202 has four metadata properties associated therewith (a PROPERTY₁, PROPERTY₂, PROPERTY₄, and a PROPERTY₆), the user can choose PROPERTY₂ to widen the search by querying the data store 102 according to a widened query 204 for other items related to this selected metadata property. One sample output 206 can then be one or a plurality of other related items, e.g., an ITEM₆ that also includes the metadata PROPERTY₂, and another related item, ITEM₁₃, that includes the metadata PROPERTY₂. The widened query 204 interfaces to the data store 102 such that the widened query 204 is applied directly thereto, and not dependent on the query 200.

As previously indicated, the architecture of the invention is capable of processing more complex queries, such that once the initial query(ies) return the related item 202, the user can be provided the option to widen the subsequent search against the data store 102 using more than one metadata property of the related item 202. For example, the user can select PROPERTY₂ and PROPERTY₆, the combination of which is processed to return other related items that include both those metadata properties. More complex queries can be performed according to the desires of the user, and as presented to the user by the architecture of the subject invention.

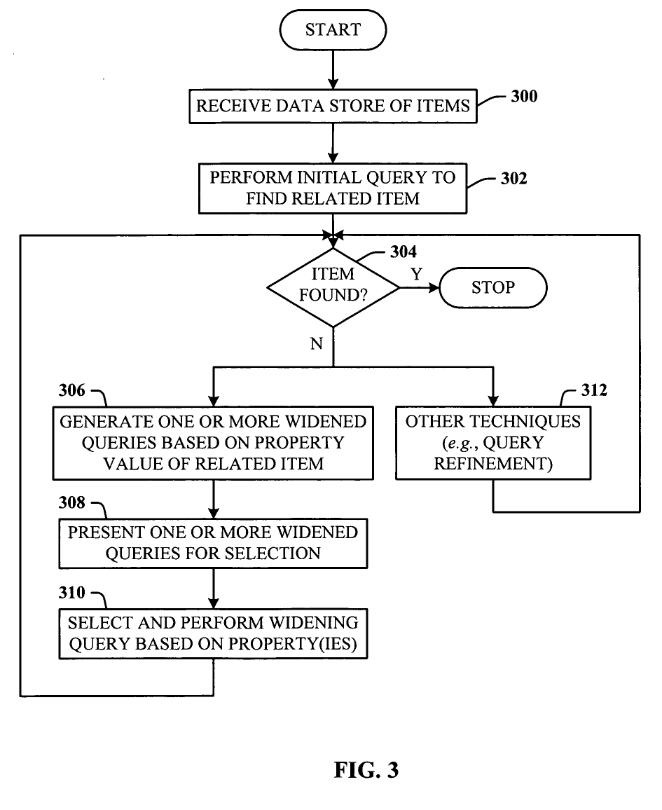

Referring now to FIG. 3, there is illustrated a flow chart of one methodology of query by association in accordance with the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 300, a data store of items is provided to be searched. At 302, one or more initial queries are performed on the data store to find items related to the query(ies). At 304, the user determines if the initial query returns the desired data. If yes, the query stops. If no, flow progresses to at least two alternative operations. At 306, a list of widening choices is constructed, where each one widens the search by choosing a property of the related item, multiple properties of the related item, a different property of two or more related items, or two or more different properties of two or more different related items. A check can also be made to determine if the widened query would return the same results as are currently being presented to the user. If the widened query would return the same results that are currently being presented to the user, it is removed from the list of widening choices. Flow proceeds back to the input of 304.

The user interaction with the architecture of the subject invention will typically be via the UI—the UI at 308 facilitates presentation of search options that widen the search based on properties of the related item(s). At 310, the user then selects one of the queries from the list of widening choices to initiate a widened search for other items related to the selected property. If the item(s) is yet not found the widening process may be repeated or other search techniques (e.g., query refinement) can be used, as indicated at 312. Flow is then back to the input of 304.

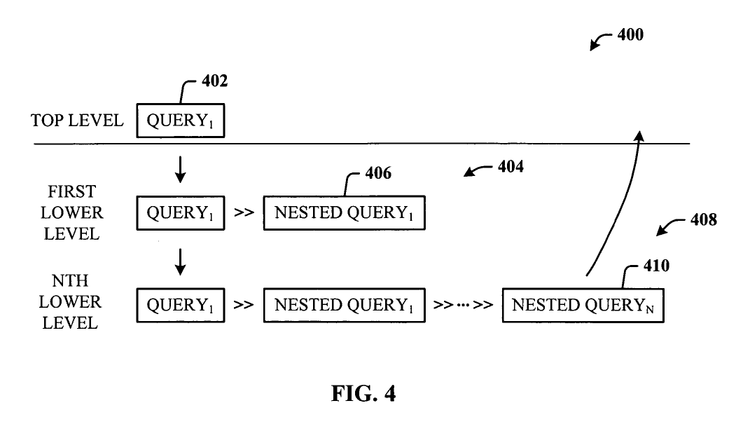

Referring now to FIG. 4, there is illustrated a diagram of a query by association process 400 where the query is widened by promoting a nested query to a top-level search in accordance with the invention. An initial query 402 (denoted QUERY₁) is performed at a top level according to a query refinement technique. If one or more items related to the top-level query 402 have not been returned, the top-level query 402 is refined to a first refined query 404, as represented at a First Lower Level, by applying a first nested query 406 (denoted NESTED QUERY₁) to the top-level query 402. Again, if the one or more items sought by the first refined query 404 are not returned, the query refinement process continues until the one or more items related to the query have been found. This can occur at an Nth Lower Level for an Nth refined query 408, where an Nth nested query 410 (denoted NESTED QUERY_{N}) that has been applied to a previous refined query can now be identified as a query that is related to the items found (or a “related query”). Once the related refined query 408 has been identified, the nested portion (NESTED QUERY_{N} 410) that facilitated finding the related items is promoted back to the top level and processed to widen the search for other related items having similar property values.

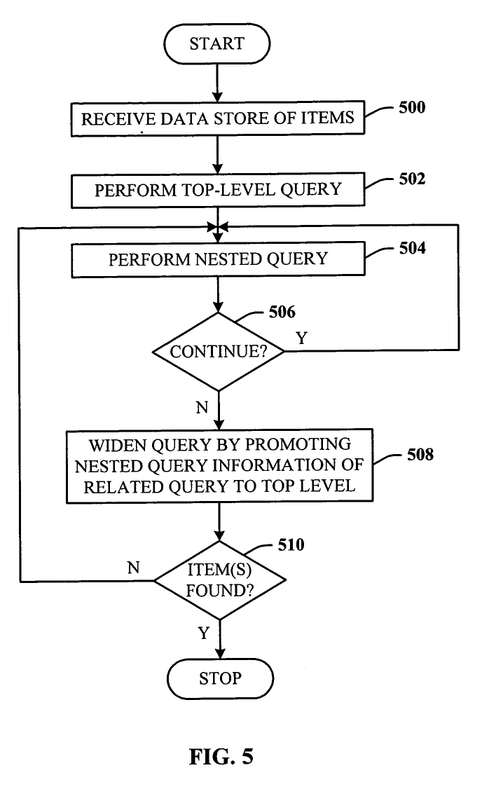

Referring now to FIG. 5, there is illustrated a flow chart of another methodology of query by association that promotes the nested query to the top level in accordance with the invention. At 500, a data store of items is provided for searching. At 502 a top-level query is performed and the results reviewed. If the results are too broad, flow progresses to 504 where one or more additional terms are added forming a nested query. At 506, a determination is made to continue with further nested querying. If yes, flow progresses back to 504. One or more queries are applied to the data store to return one or more items related to the query. Once the related items are found, the related query can be identified. At 508, the search is then widened by promoting the nested query to the top level. At 510, if the desired item(s) have been not been found, flow proceeds back to 504 to continue the query. If, at 510, the desired results have been returned, the search stops.

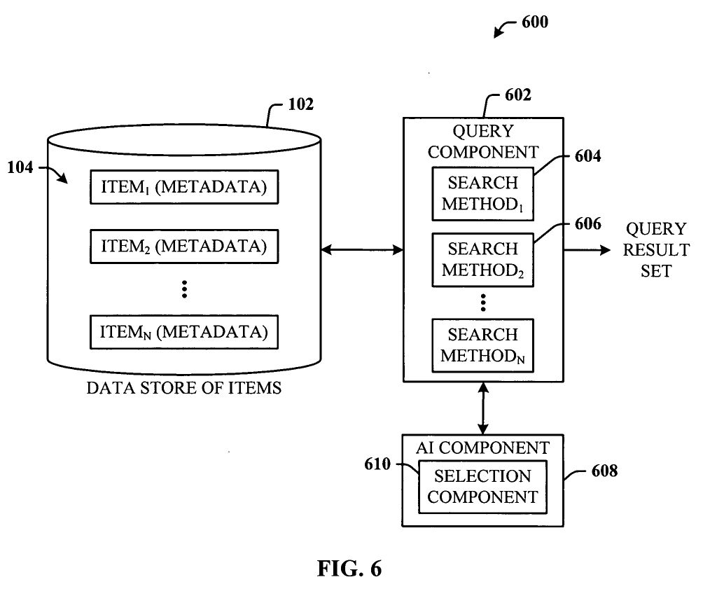

Referring now to FIG. 6, there is illustrated a block diagram of a system 600 that employs artificial intelligence (AI) to facilitate searching the data store 102 of items in accordance with the subject invention. As before, the data store 102 includes data items 104 (denoted ITEM₁, ITEM₂, . . . ,ITEM_{N}) any or all of which have associated therewith metadata. A query component 602, similar to query component 106 of FIG. 1, interfaces to the data store 102 to facilitate one or more queries on the data store of items 102, which queries can eventually output a query result set.

The system 600 supports at least both implementations (or search methods) of the query by association techniques describe herein with respect to FIG. 1. Here, the query component 602 includes a first search method 604 (denoted SEARCH METHOD₁), a second search method 606 (denoted SEARCH METHOD₂), to an Nth search method (denoted SEARCH METHOD_{N}). It should be understood that the query component 602 facilitates searching, such that any or all of the search methods (1, . . . ,N) can be employed externally (remote and/or proximate) to the query component 602, but accessed thereby to facilitate the data store searches.

In any case, a search method can be selected for searching the data store. In one implementation, the selection process is facilitated by the query component such that the user can select the search method manually. This can be accomplished according to a default setting that is configurable by the user. Alternatively, this can be provided as a graphical user interface (GUI) selection button or drop-down menu option that is presented in an application (e.g., a browser) for searching a data store (e.g., a web-based data store that is accessible by a web-based search engine). Here, the first search method 604 can be the first implementation, and the second search method 606 can be the second implementation, both of which are described herein.

Additionally, in this particular embodiment, the system 600 includes an AI component 608 that facilitates learning and automating various functions in accordance with such technologies. The subject invention can employ various AI-based schemes for carrying out various aspects thereof. For example, a process for determining when to employ a more complex query can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data), as well as implicitly trained (e.g., via observing user behavior, receiving extrinsic information). For example, SVM's are configured via a learning or training phase within a classifier constructor and feature selection module. Thus, the classifier(s) can be used to automatically perform a number of functions, including but not limited to, the following: determining what search terms to use for a given document item; learning what search terms are typically used by a user for a given set of data and employing those search terms automatically when such set of data appears to be that which the user is searching; and, automatically determining which properties of the metadata may be more interesting to use for a search, and give a reasonable number of results.

In one example, a user desires to look at a first document, and then to look at other documents related to the approximate same time that the first document was created. (Note the temporal information can also include when the first document was accessed, edited, saved, etc.) The creation time can be in the same hour, same day, same week, same year, etc. By detecting how many related documents are in the each of these time periods, the user or the system can choose the document(s) that are the most likely to be looked at by the user. Thus, the system can determine automatically that the user does not want to look at only one document on the same date, since there is only one document on that date. Additionally, the system can automatically determine that the user does not want to look at a document of the same year, where there are thousands returned by the search. Thus, based on the number of documents in each of the time periods, the system can determine with a high degree of certainty, the proper suggested document(s) to return for viewing by the user.

The results of the AI analysis may be used to modify the list of widening choices created at 304. Some widening choices may be dropped from the list as less likely to be selected by the user, and other choices may be added. In addition, AI may improve performance by initiating query evaluation for the choices that are most likely to be selected by the user. Once the user makes the choice, the query is already pre-calculated and the results may be displayed immediately. In some cases, the widened queries deemed by AI to be most interesting may be displayed to the user without the need for the user to make an explicit choice.

In another example, the AI component 608 can facilitate the type of metadata search terms, number of terms, and the combination of metadata search terms that can be used by a given user, and/or related to the topic of the search. For example, as described hereinabove with respect to FIG. 2, the user can choose more than one metadata property to search. In accordance with implementation of the AI component 608, the same operation can be automated whereby the multiple search terms are automatically selected for use in the search.

In yet another example, the AI component 608 can facilitate determination of the level to which refinement occurs before promoting the search term to the top level. For example, the AI component 608 can automatically perform refinement to a 6^{th} level, but decide that the last fifth search term of the previous 5^{th} level is more relevant thereby promoting the fifth search term to the top level to widen the search, rather than promoting the sixth search term of the 6^{th} level for search widening.

Many other variations related to the selection of search terms and analysis of the search results, for example, can be implemented using the AI component 608, and are within contemplation of the subject invention. For example, the AI component 608 can be employed to determine according to predetermined criteria which of the search methods (1, . . . ,N) should be utilized. In support thereof, the AI component 608 further includes a selection component 610 that facilitates selecting one or more of the search methods. In one implementation, the AI component 602 automatically detects the type of data store to be searched (e.g., a web-based data store versus a personal computer hard drive data store) and, in response thereto, either suggests to the user a more suitable search method, automatically employs the more suitable method, or automatically employs a preconfigured default search method.

In another implementation, the selection component 610 can be employed to determine which search method should be utilized based on the platform in which the data store resides. For example, if the data store resides in non-volatile flash memory in a portable device, given the presentation limitations, storage limitations and processing limitations normally associated with such a small device, it is more likely, for example, that the first implementation of searching for related items by using properties, rather than query refinement to find a related query, will be more efficient.

As indicated herein, the AI component 608 can learn or make an inference as to which implementation and/or features should be employed. For example, when the user hovers over a result set item, a menu is presented that provides one or more property values related to that item for widening the query. The AI component 602 can be employed to determine if some or all of the property values should be presented to the user. For example, if in the past, the user typically selects one of the many property values displayed for a given type of data, the AI component 602 will learn this and anticipate that the user will choose this same property in the future. Thus, the menu can be sorted to present this selection first in the list of properties, or even decide not to show the other properties. This is particularly useful where a large number of properties are associated with an item, and presentation thereof is cumbersome or inefficient.

In yet another variation on this theme, the AI component 602 can detect the time and/or date that the user is accessing the data store, and infer features and/or selections based thereon. For example, if the day is Friday (associated with the end of a pay period), the time of day is near the end of business, and the data store items are payroll related, the AI component 602 can infer that the user will choose a search method that promptly returns payroll check items, and present property values that include name, hours, amount, deductions, and taxes, to name just a few. This can be in lieu of further presenting property values such as trip information, reimbursements, and so on, which are not typically related with generating payroll.

Given that many computer operating systems typically include user profile information, the AI component 602 can automatically access the profile information to assist in determining features and/or search methods to implement. As will be understood by one skilled in the art, many other types of data and information can be detected, accessed, and processed to further automatic searches in accordance with the subject invention.

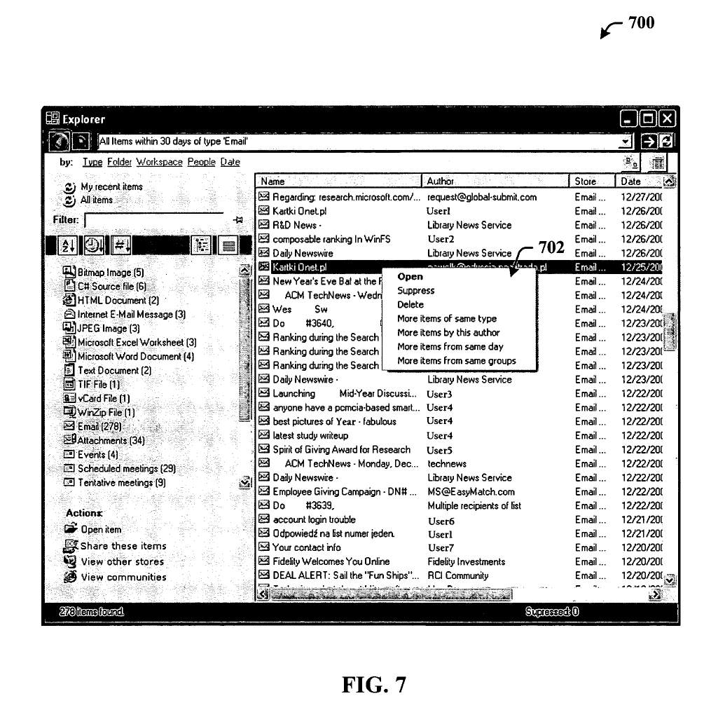

FIG. 7 illustrates a UI screenshot 700 of results of an initial query to find a related item, where the related item is used to widen the search in accordance with the subject invention. In this example, an initial query is made for “All items within 30 days of type ‘Email”’, which query returns a large result set. Once a related item (e.g., an e-mail document) is found, the user can hover a pointing device cursor over a returned item (e.g., the highlighted item of FIG. 7) in response to which a right-click menu 702 is presented that includes sample widened queries of related metadata properties. In this implementation, four widened queries are presented that facilitate searching for more items of the same type, author, day, or in the same group (or folder).

In general, the set of available widened queries can be adjusted depending on the current item and view. Widening by a given property may not be interesting if the property has no value or a default value (e.g., no “More items by this author” query if an “author” property is not set). Similarly, the widened query can be excluded if the results returned happen to be the same results as the presented in current view (e.g., no “More items of same type” widening option if presented if the current view is “All items of type ‘e-mail”’).

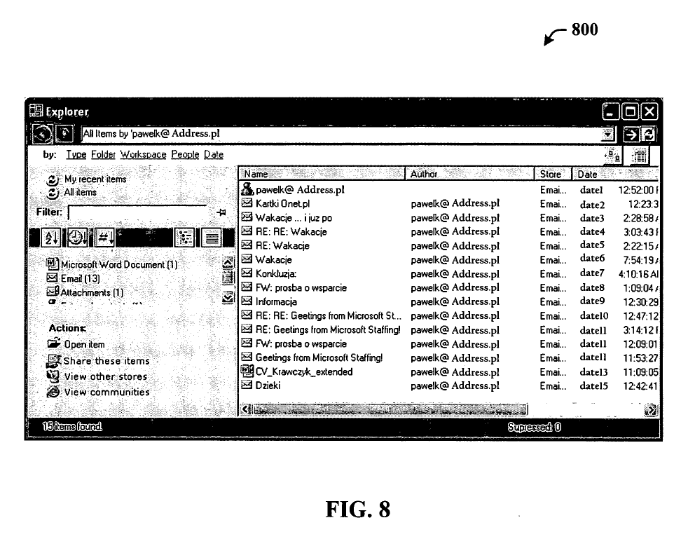

FIG. 8 shows a screenshot 800 of search results that are returned from executing a widened query “More items by this author” as selected by the user in accordance with the invention. An interesting observation is that the result set includes many items that were not present in the result set of FIG. 7. This includes items that are older than thirty days, as well as items that are not e-mail messages (e.g., an address book entry and a word processing document). This illustrates a major difference between conventional query refinement and query widening of the subject invention. Query widening can return items that are outside of the initial result set. This is accomplished by selectively returning only the items that share the same property.

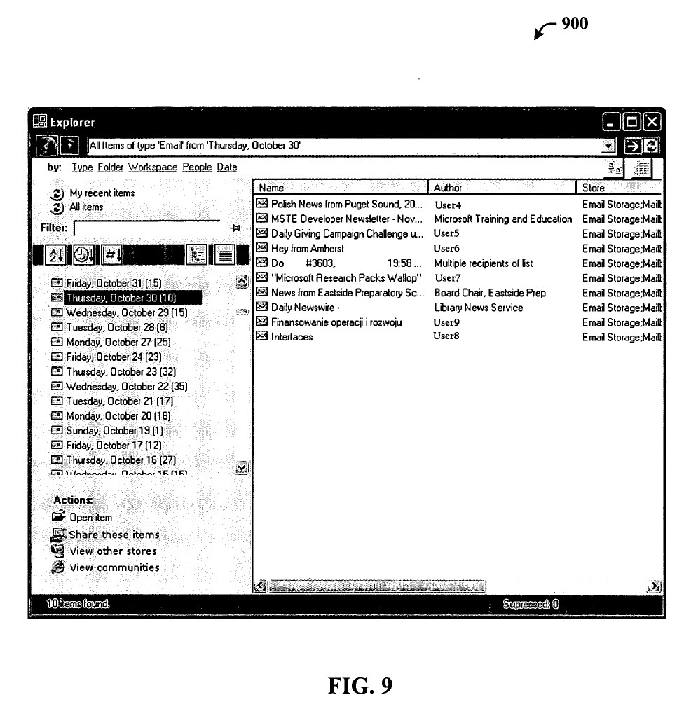

Consider a case where a user is looking for an e-mail message that was received from another user who was met at a party. One way to find such information is by a property value that is the party date. FIG. 9 shows a UI screenshot 900 of results returned using a conventional search that sorts e-mail by date. As illustrated, grouping all e-mail messages by date is not particularly useful, since the user will typically receive many messages each day, and finding the right date can be a challenge.

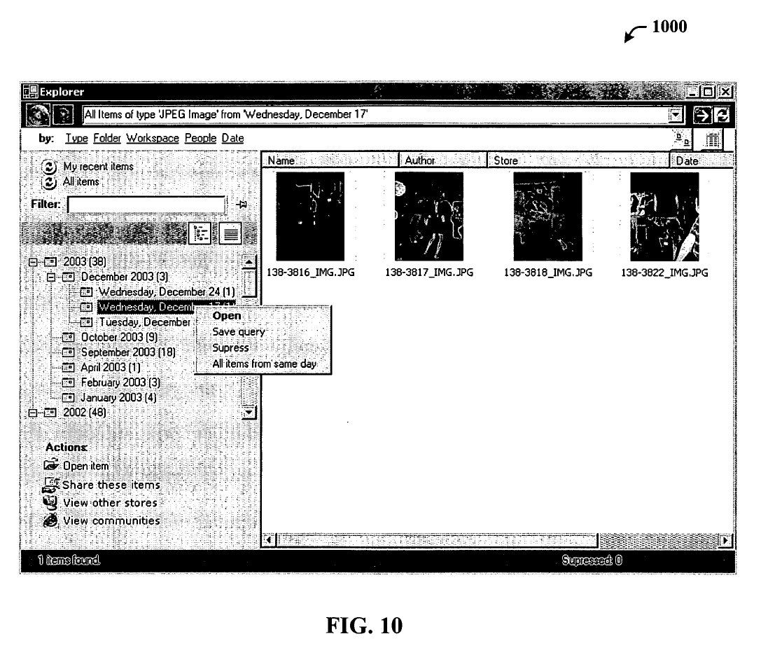

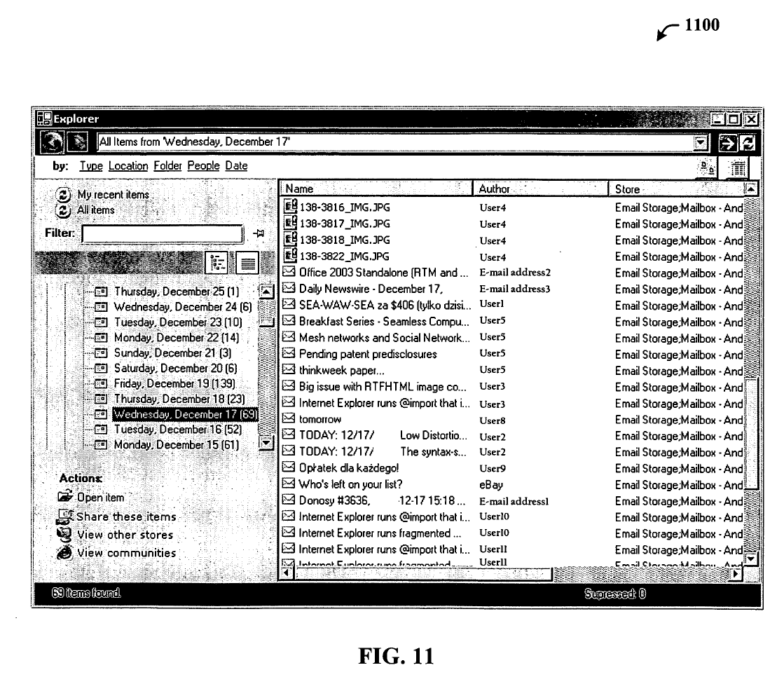

However, if the user opens a UI view that shows all pictures grouped by date, the task of figuring out the date of the party is much easier. Since all pictures are clustered only around important social events, there are just a few dates to choose from. It is even easier if a picture preview is provided. FIG. 10 illustrates a picture view screenshot 1000 of query by association where a related query is found and then promoted to a top level search in accordance with the subject invention. Constructing the query using the right property value(s) (in this case, party date) is much simpler if the item set is limited to related items (in this case, pictures). Once the party date has been found, one-click access is provided to a widening option “All items from same day” through a command on the query right-click menu. This is a specific example of an action command for a nested query that allows moving from a narrow scope (“All items of type ‘Pictures’ from ‘Thursday, October 23”’) to a wider scope (“All items from ‘Thursday, October 23”’). The results of the widened query are shown in a screenshot 1100 of FIG. 11. Using a breadcrumb bar notation, the query proceeds from Type: Pictures>>Date: October 23 to Date: October 23. This transformation can be described as removing all containment queries and going with the inner query to the largest possible scope.

There can be some cases when such a transformation is not possible. For example, “Date picture taken” is a property that is defined only for objects of type picture. In such cases, the architecture of the subject invention will not display the command to widen the query. This falls into the category that the view created by the new widened query would be the same as the current view.

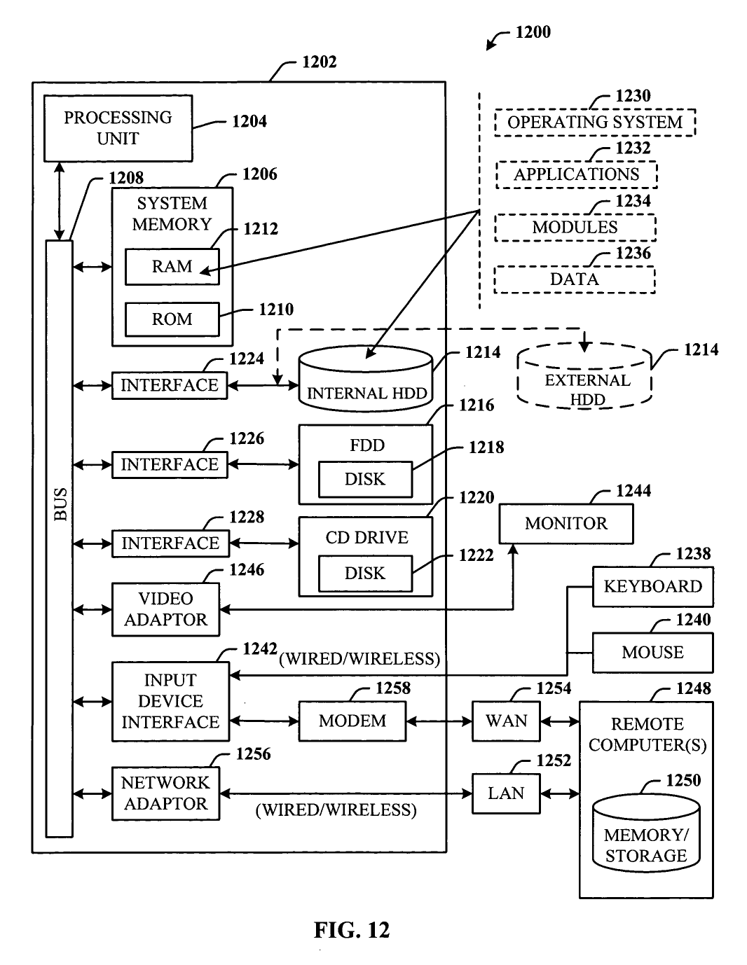

Referring now to FIG. 12, there is illustrated a block diagram of a computer operable to execute the disclosed architecture. In order to provide additional context for various aspects of the subject invention, FIG. 12 and the following discussion are intended to provide a brief, general description of a suitable computing environment 1200 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, there is illustrated an exemplary environment 1200 for implementing various aspects of the invention that includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the invention can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.12 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

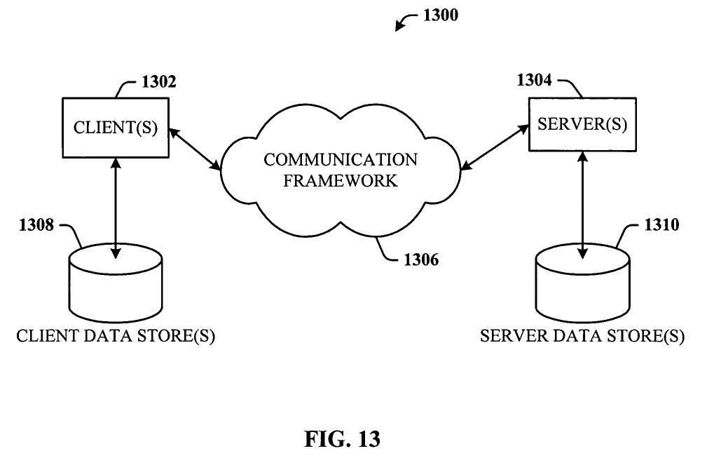

Referring now to FIG. 13, there is illustrated a schematic block diagram of an exemplary computing environment 1300 in accordance with the subject invention. The system 1300 includes one or more client(s) 1302. The client(s) 1302 can be hardware and/or software (e.g., threads, processes, computing devices). The client(s) 1302 can house cookie(s) and/or associated contextual information by employing the invention, for example.

The system 1300 also includes one or more server(s) 1304. The server(s) 1304 can also be hardware and/or software (e.g., threads, processes, computing devices). The servers 1304 can house threads to perform transformations by employing the invention, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates a data store query, comprising:
a data store of items that have metadata associated therewith; and
a query component that facilitates generation of a query on the data store of items to return one or more related items, and widening of the query by searching for an other related item based on metadata of the one or more related items.

2. The system of claim 1, wherein the metadata includes at least one property value that is used to widen the search for the other related item.

3. The system of claim 2, wherein the other related item is associated with the at least one property value.

4. The system of claim 1, wherein the metadata includes a property value that is at least one of a item type, date, author and group.

5. The system of claim 1, wherein the query component facilitates presentation of one or more query options that are selectable by a user to widen the search.

6. The system of claim 5, the one or more query options include properties of the metadata.

7. The system of claim 1, further comprising an artificial intelligence (AI) component that employs a probabilistic and/or statistical-based analysis to prognose or infer an action that a user desires to be automatically performed.

8. The system of claim 7, wherein the AI component facilitates automatic widening of the query.

9. A computer readable medium having stored thereon computer executable instructions for carrying out the system of claim 1.

10. A computer that employs the system of claim 1.

11. A method of searching a data store of items, comprising:
performing a query on the data store of items to find a related item, which related item has metadata associated therewith; and
widening the query by searching for other related items based on the metadata.

12. The method of claim 11, wherein the act of widening includes searching for the other related items based on a property of the metadata.

13. The method of claim 11, wherein the metadata includes a property value that is at least one of an item type, date, author, and group.

14. The method of claim 11, further comprising presenting one or more query options in the form of properties of the related item that are selectable by a user to widen the search.

15. The method of claim 11, further comprising automatically performing an action using an AI component that employs a probabilistic and/or statistical-based analysis to prognose or infer the action.

16. A computer-readable medium having computer-executable instructions for performing a method of claim 11.

17. A method of searching a data store of items, comprising:
querying the data store of items using a first query to find related items;
extracting one or more property values associated with the related items; and
widening the search by searching for other related items using the one or more property values.

18. The method of claim 17, further comprising at least one of the acts of:
presenting the one or more property values to a user for selection to initiate the act of widening; and
automatically executing the act of widening according to the one or more property values.

19. The method of claim 17, the act of widening returns one or more of the other related items that are not included in the related items.

20. A system that facilitates searching a data store, comprising:
a data store of items; and
a query component that facilitates determination of a related query that returns one or more related items, and widening of the search by utilizing a nested query of the related query to return one or more other related items.

21. The system of claim 20, wherein the related query is determined according to a query refinement technique.

22. The system of claim 21, wherein the one or more other related items are associated with at least one property value.

23. The system of claim 20, wherein a property value associated with the nested query is utilized to widen the search.

24. The system of claim 20, wherein the query component facilitates presentation of one or more query options that are selectable by a user to widen the search.

25. The system of claim 20, wherein the nested query is associated with metadata properties that include at least one of an item type, date, author and group.

26. The system of claim 20, further comprising an AI component that employs a probabilistic and/or statistical-based analysis to prognose or infer an action that a user desires to be automatically performed.

27. The system of claim 26, wherein the AI component facilitates automatic widening of the query.

28. A computer readable medium having stored thereon computer executable instructions for carrying out the system of claim 20.

29. A computer that employs the system of claim 20.

30. A server according to the system of claim 20.

31. A computer-readable medium having computer-executable instructions for performing a method of searching a data store of items, comprising:
querying the data store of items to determine a related query that is associated with one or more related items;
extracting a nested query from the related query; and
widening the search of the data store of items by utilizing the nested query to return other related items.

32. The method of claim 31, further comprising widening the search by utilizing one or more property values associated with the nested query.

33. The method of claim 31, further comprising generating the related query according to a query refinement technique.

34. The method of claim 31, further comprising presenting one or more query options that are selectable by a user to widen the search.

35. The method of claim 31, wherein the nested query is associated with metadata properties that include at least one of an item type, date, author and group.

36. A computer-readable medium having computer-executable instructions for performing a method of searching a data store of items, comprising:
querying the data store of items to determine a related query that is associated with one or more related items;
performing at least one of the acts of:
extracting one or more property values associated with the one or more related items; and
extracting one of a nested query from the related query and one or more property values associated therewith; and
widening the search of the data store of items to return other related items based on at least one of the nested query and the one or more property values.

37. The method of claim 36, the other related items include items that are not part of the one or more related items.
